(19) United States
(12) Patent Application Publication
(10) Pub. No.: US 2017/0307217 A1
(43) Pub. Date: Oct. 26, 2017

(54) GAS TURBINE COMBUSTION CHAMBER

(71) Applicant: Rolls-Royce Deutschland Ltd & Co KG, Blankenfelde-Mahlow (DE)

(72) Inventor: Carsten CLEMEN, Mittenwalde (DE)

(21) Appl. No.: 15/491,116

(22) Filed: Apr. 19, 2017

(30) Foreign Application Priority Data
Apr. 26, 2016 (DE) 10 2016 207 057.6

(51) Int. Cl. F23R 3/04; F02C 7/18; F23R 3/00

(52) U.S. Cl. CPC F23R 3/04; F23R 3/002; F02C 7/18; F05D 2220/32; F05D 2240/35; F23R 2900/03041; F23R 2900/03044

(57) ABSTRACT

A gas turbine combustion chamber with a double-wall embodiment, having an outer cold combustion chamber wall and an inner hot combustion chamber wall which form an intermediate space, with impingement cooling holes in the outer combustion chamber wall, effusion cooling holes in the inner combustion chamber wall, outer mixing holes in the outer combustion chamber wall, and inner mixing holes in the inner combustion chamber wall. Respectively, one tubular mixing element connects the outer mixing hole and the inner mixing hole, wherein the mixing element includes an inflow opening in its area which is arranged inside the intermediate space. The outer mixing hole has a smaller diameter than the inner mixing hole, and the throughflow surface area of the effusion holes that are adjoining the mixing element is reduced by the difference in surface area between the outer mixing hole and the inner mixing hole.

This application claims priority to German Patent Application 102016207057.6 filed Apr. 26, 2016, the entirety of which is incorporated by reference herein.

### DESCRIPTION

The invention relates to a gas turbine combustion chamber, in particular for an aircraft gas turbine.

More particularly, the invention relates to a gas turbine combustion chamber with the features of the generic term of claim 1.

What is already known from the state of the art are different constructions of gas turbine combustion chambers, in particular annular combustion chambers. With regard to that, it is referred to EP 0 780 638 A2. In such gas turbine combustion chambers, additional air is guided into the internal space of the combustion chamber through mixing openings in order to optimize the combustion, and in particular to reduce NOx emissions.

In the known constructions, a predefined amount of air is available for cooling the combustion chamber and for mixing the air. This results in the disadvantage that less air for cooling the combustion chamber walls is available when the mixing air is increased. It is known from the state of the art to enlarge the mixing holes in order to minimize NOx generation, and at the same time to reduce the number of cooling air holes in the combustion chamber wall, or to decrease their diameter. However, in total this results in an inferior cooling of the combustion chamber wall. This in turn has the consequence that, in the known constructions, the air that is guided through the mixing holes cannot be increased any further without having to accept considerable disadvantages with respect to the cooling the combustion chamber wall.

The invention is based on the objective to create a gas turbine combustion chamber of the abovementioned kind that facilitates a good cooling of the combustion chamber wall as well as a sufficient feed of mixing air, while at the same time having a simple structure as well as a simple, cost-effective manufacturability.

According to the invention, the objective is achieved by means of a combination of the features of claim 1, with the subclaims showing further advantageous embodiments of the invention.

What has thus been created according to the invention is a gas turbine combustion chamber that has a double-wall embodiment with an outer cold combustion chamber wall as well as with an inner hot combustion chamber wall. Here, the terms “outer” and “inner” refer to the combustion space and the gases that flow through the combustion chamber. The outer combustion chamber wall is provided with impingement cooling holes through which the cooling air can enter an intermediate space between the outer and the inner combustion chamber wall so as to cool the outer side of the inner combustion chamber wall. Effusion cooling holes are provided inside the inner combustion chamber wall in order to guide cooling air through the inner combustion chamber wall and to protect the latter from the hot combustion gases by means of a cooling air film.

Mixing holes through which mixing air can flow into the combustion space are embodied in the outer combustion chamber wall as well as in the inner combustion chamber wall. At that, the outer combustion chamber wall has outer mixing holes and the inner combustion chamber wall has inner mixing holes.

The mixing holes can be embodied so as to be distributed around the circumference in one row or in two rows. The respective outer and inner mixing hole are connected by a tubular mixing element through which the mixing air can flow from the external side of the combustion chamber and be introduced into the internal space of the combustion chamber into the area of the combustion zone.

In its area that is arranged in the intermediate space, the mixing element is provided with at least one inflow opening through which cooling air can flow from the intermediate space into the mixing element.

Further, the outer mixing hole has a smaller diameter than the inner mixing hole. In order to determine the additional amount of air that flows through the mixing element, it is provided that the throughflow surface area of the effusion cooling holes that adjoins the mixing element is reduced by the surface area difference between the outer mixing hole and the inner mixing hole. Thus, the solution according to the invention provides that a larger amount of air is introduced into the intermediate space through the impingement cooling holes. This cooling air cools the inner combustion chamber wall, but instead of being subsequently guided through the effusion cooling holes into the combustion chamber internal space in its entirety, it is partially introduced into the mixing element in order to optimize the combustion process as mixing air. Thus, the amount of air that is introduced through the impingement cooling holes remains constant in comparison to previously known constructions. According to the invention, only the amount of air that is guided through the effusion holes is reduced. Due to the cooling of the inner combustion chamber wall by means of the cooling air that is introduced through the impingement cooling holes, a sufficient cooling of the inner combustion chamber wall is ensured, so that the latter is not subject to heightened wall temperatures. An undesired heating of the inner combustion chamber wall is thus avoided. This leads to a longer service life of the inner combustion chamber wall and prevents it from being damaged, for example through melting or similar processes.

In a particularly advantageous further development, it is provided that a mixing element is embodied in the form of a ring-like flange that is mounted at the inner combustion chamber wall. In this way, it is possible to realize single-piece constructions of the outer and inner combustion chamber wall, as well as constructions in which the inner combustion chamber wall is manufactured independently of the outer combustion chamber wall, for example in the form of shingles.

The mixing air holes, which are arranged so as to be distributed evenly around the circumference of the combustion chamber, can be provided in one row or in two rows. A one-row embodiment should lead to good results.

The inflow opening that is provided at the mixing element in order to introduce cooling air from the intermediate space into the mixing element is preferably embodied in a flow-optimized manner. It can have a round, oval, or slit-like design, but it can also be designed so as to be inclined with respect to a central axis of the mixing element. The various measures result in optimized flow conditions, depending on the respective construction of the gas turbine combustion chamber. Here, it can be particularly advantageous if the inflow opening or the multiple inflow openings are arranged in the flow direction of the cooling air through the intermediate space. This leads to a farther improvement of the flow conditions. In total, it is possible within the framework of the invention to provide multiple inflow openings or only one single large inflow opening at the circumference of the mixing element.

By reducing the number of effusion cooling holes or of the effective diameters of the effusion cooling holes it can be achieved that the sum of the throughflow surface areas of the impingement cooling holes and of the outer mixing holes is equal to the sum of the throughflow surface areas of the effusion cooling holes and the inner mixing holes. This may refer either to an area that is adjacent to the mixing holes arranged at the circumference, or to the entire combustion chamber.

In the following, the invention is described based on exemplary embodiments in connection with the drawing. Herein:

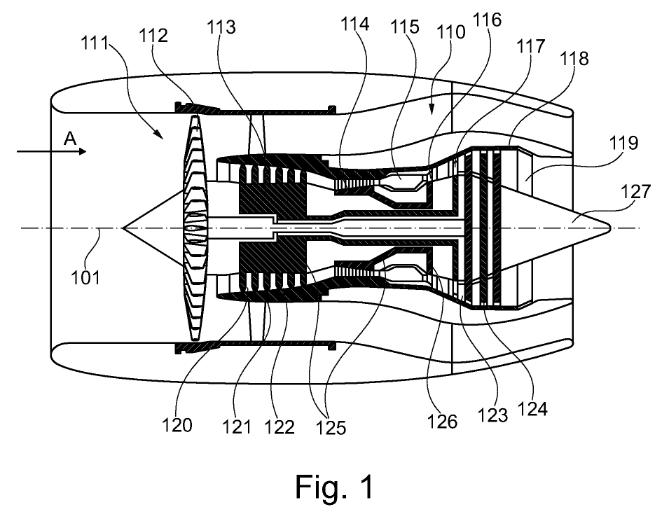

FIG. 1 shows a gas turbine engine for the use of a gas turbine combustion chamber according to the invention,

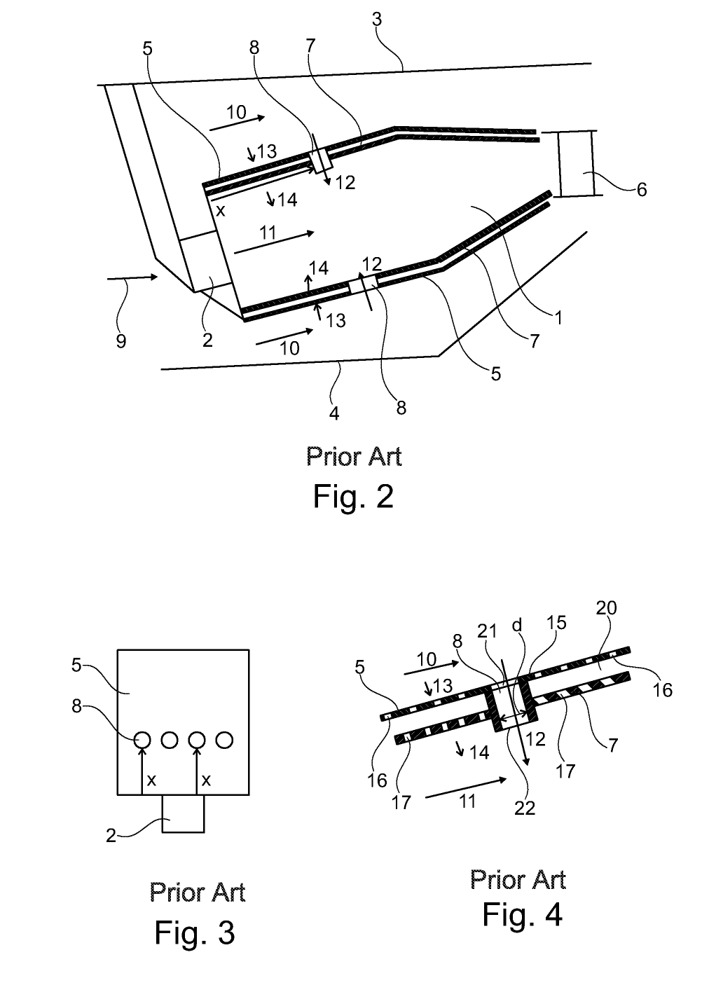

FIG. 2 shows a simplified axial sectional view of a combustion chamber that is known from the state of the art,

FIG. 3 shows a partial top view according to FIG. 2, and

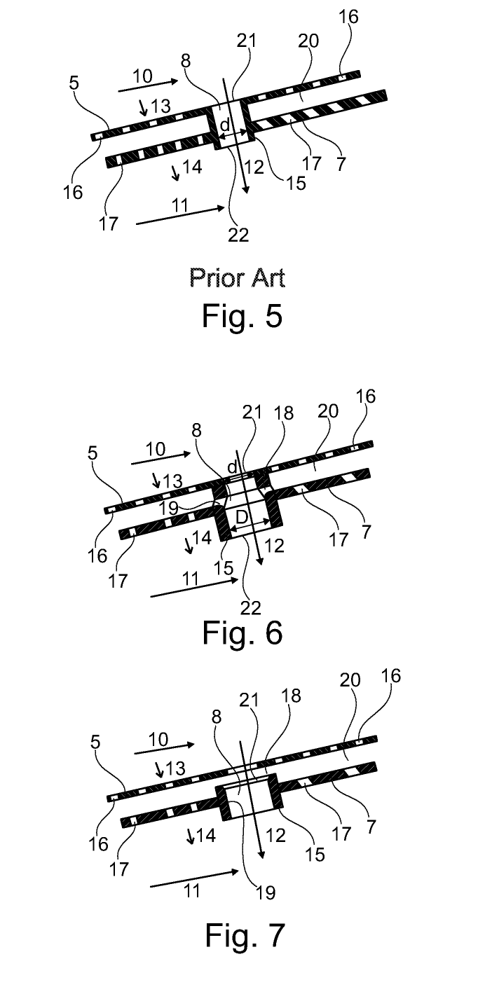

FIGS. 4, 5 show axial partial sectional views of the outer and inner combustion chamber wall with mixing according to the state of the art,

FIG. 6 shows a partial axial sectional view, analogous to FIGS. 4 and 5, of a first exemplary embodiment of the invention,

FIG. 7 shows a sectional view, analogous to FIG. 6, of a further exemplary embodiment,

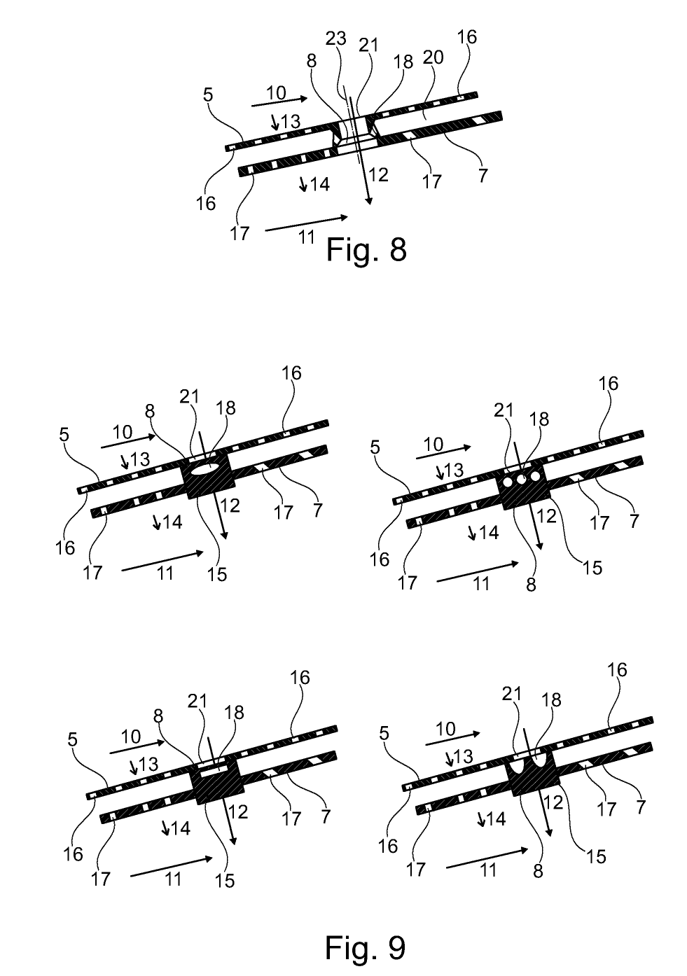

FIG. 8 shows a sectional view, analogous to FIGS. 6 and 7, of an additional exemplary embodiment, and

FIG. 9 shows sectional views analogous to FIGS. 6 to 8 including the rendering of exemplary embodiments of inflow openings.

The gas turbine engine 110 according to FIG. 1 shows a general example of a turbomachine in which the invention can be used. The engine 110 is embodied in a conventional manner and comprises, arranged in succession in flow direction, an air inlet 111, a fan 112 that rotates inside a housing, a medium-pressure compressor 113, a high-pressure compressor 114, a combustion chamber 115, a high-pressure turbine 116, a medium-pressure turbine 117, and a low-pressure turbine 118, as well as an exhaust nozzle 119, which are all arranged around a central engine axis 101.

The medium-pressure compressor 113 and the high-pressure compressor 114 respectively comprise multiple stages, of which each has an arrangement of fixed static guide vanes 120 that extend in the circumferential direction and are generally referred to as stator blades, protruding radially inward from the core engine housing 121 through the compressors 113, 114 into an annular flow channel. The compressors further have an arrangement of compressor rotor blades 122 that protrude radially outward from a rotatable drum or disc 125 and that are coupled with hubs 126 of the high-pressure turbine 116 or the medium-pressure turbine 117.

The turbine sections 116, 117, 118 have similar stages, comprising an arrangement of fixed guide vanes 123 that protrude radially inwards from the housing 121 through the turbines 116, 117, 118 into the annular flow channel, and a subsequent arrangement of turbine blades 124 that protrude outwards from a rotatable hub 126. During operation, the compressor drum or compressor disc 125 and the blades 122 arranged thereon as well as the turbine rotor hub 126 and the turbine rotor blades 124 arranged thereon rotate around the engine central axis 101. A indicates the entering air flow.

FIGS. 2 to 5 show constructions according to the state of the art. Here, a gas turbine combustion chamber is explained in a simplified illustration in FIG. 2. It has a combustion space 1 through which air 11 flows during the combustion process, as shown in FIG. 2. The combustion chamber has a fuel nozzle 2. The reference sign 3 shows an outer housing, while an inner housing is illustrated in a simplified manner as indicated by the reference sign 4. The combustion chamber is embodied with a double-wall and comprises an outer combustion chamber wall 5 as well as an inner combustion chamber wall 7. The mentioned fuel nozzle 2 is provided in the inflow area, and the outflow takes place through a turbine inlet guide vane 6.

The combustion chamber has a single-row arrangement of mixing openings, which is indicated in a simplified manner as mixing by reference sign 8. The air that enters the area of the fuel nozzle 2 is indicated by the reference sign 9. An air flow 10 flows through the combustion chamber between the outer housing 3 and the inner housing 4, with cooling air 13 from the air flow 10 being introduced through the impingement cooling holes 16 into an intermediate space 20 between the outer combustion chamber wall 5 and the inner combustion chamber wall 7 (see FIGS. 4 and 5). In addition, air 12 flows through the mixing 8. From the intermediate space 20, cooling air flows into the combustion space 1 through the effusion cooling holes 17 (see FIGS. 4 and 5).

While the known combustion chamber is shown in FIG. 2 in an axial sectional view, FIG. 3 shows a top view of the outer combustion chamber wall 5. Here, it can again be seen that the mixing openings of the mixing 8 are arranged so as to be evenly distributed around the circumference 30. They have a distance x from the plane of the fuel nozzle 2.

FIGS. 4 and 5 show two different basic design options of the combustion chamber walls 5 and 7. They can be embodied as separate structural components, as it is shown in FIG. 4. As can be seen here, the mixing element 15 is attached to the inner combustion chamber wall 7, or it can be embodied in one piece with the same. The mixing element 15 has an outer mixing hole 21 and an inner mixing hole 22. In the exemplary embodiment of FIG. 5, the outer combustion chamber 5, the inner combustion chamber 7, and the mixing element 15 are embodied in a single piece.

As clarified in FIGS. 4 and 5, the cooling air 13 flows into the intermediate space 20 through the impingement cooling holes 16, thus cooling the external side of the inner combustion chamber wall 7. Subsequently, the cooling air flows through the effusion cooling holes 17 into the combustion space and forms a cooling air layer serving for the protection of the inner combustion chamber wall 7. Thus, the cooling air 14 forms a cooling air film and flows along the interior side of the inner combustion chamber wall 7.

Air 12 flows through the mixing element 5 and is guided into the combustion space 1 in the form of discrete jets to be mixed there with the air 11 and the fuel, and to thus lean the combustion chamber gases. In this manner, NOx generation is minimized. In the two-part embodiment of the combustion chamber wall that is shown in FIG. 4, the mixing element 15 provides a seal towards the interior side of the outer combustion chamber wall 5 as it is supported against the outer combustion chamber wall. In the one-piece embodiment shown in FIG. 5, such a sealing is not necessary.

In the constructions known from the state of the art, it is disadvantageous that less air can be guided through the impingement cooling holes 16 and the effusion cooling holes 17 as the mixing 8 is being increased. This leads to the wall temperature rising as a consequence of reduced cooling. As a result, the service life of the combustion chamber wall is reduced, since it may melt, for example.

FIG. 6 shows an exemplary embodiment analogous to the rendering of FIGS. 4 and 5. As can be seen here, according to the invention the outer mixing hole 21 of the mixing element has a smaller diameter than the inner mixing hole 22. Further, FIG. 6 shows that a smaller number of effusion cooling holes 17 is embodied at least in the area of the mixing element 15.

The mixing element 15 has inflow openings 18 that are distributed around the circumference, with their walls being provided with a radius 19 for the purpose of flow optimization.

A comparison of the exemplary embodiment of FIG. 6 and the construction according to FIG. 4 known from the state of the art leads to the following: For the subsequent contemplation, the amount of air [g/s] passing through the impingement cooling holes 16 is indicated by x, the amount of air [g/s] passing through the effusion cooling holes 17 by x, and the surface area of the effusion cooling holes 17 by X. The amount of air [g/s] passing through the mixing 8 is indicated by y. The internal diameter of the mixing 8 [mm] is d. The surface area of the admixed amount 8 [mm2] is 0.25*π*d 2.

A comparison of FIGS. 4 and 6 yields that in the present invention an additional amount of air a is additionally introduced through the mixing 8, and is channeled out through the inner mixing hole 22. This additional mixing air can be set in any desired manner, with realistic values lying at 0.1 to 0.4. Thus, the amount of air that flows out from the inner mixing hole 22 is increased by this factor in contrast to the amount of air that flows in through the outer mixing hole 21. Assuming an exemplary diameter of d=10 mm, the amount of air passing through the impingement cooling holes 16 is indicated by x, and the amount of air passing through the effusion cooling holes 17 is defined as (1−a)*x. Accordingly, the surface area of the effusion cooling holes 17 is (1−a)*X. The amount of air [g/s] y is introduced through the outer mixing hole 21, while an amount of air [g/s] a*x is supplied through the inflow openings 18. The total amount of air that flows out through the inner mixing hole 22 is thus y+a*x. Given a diameter d of the outer mixing holes 21, what results is a surface area of the outer mixing holes 21 [mm2] of 0.25*π*d2. The surface area of the inner mixing holes 22 is 0.25*π*d2*(1+a). The diameter D of the inner mixing holes 22 is D=d*. In the example in which d=10 mm and a=0.2, what thus results is D=10.95 mm. According to the invention, preferred values of D/d lie between 1.05 and 1.2.

FIG. 7 shows an exemplary embodiment in which the inflow opening 18 is embodied as a ring in which the mixing element 15 has a distance to the outer combustion chamber wall 5.

FIG. 8 shows an exemplary embodiment in which a central axis 23 of the mixing opening 8 is shown. Here, the inflow openings 18 are inclined with respect to the central axis 23 25 in order to optimize the flow conditions.

FIGS. 6 to 8 show that in total less effusion cooling holes 17 are embodied in the area of the mixing 18 as compared to the state of the art according to FIG. 4.

FIG. 9 shows different embodiment variants of the inflow openings 18. According to the variant on the top left in FIG. 9, an inflow opening 18 with an oval cross-section is provided, while in the exemplary embodiment of FIG. 9 on the top right multiple circular inflow openings 18 are provided. The variant on the top left according to FIG. 9 shows a slit-like embodiment of the inflow opening 18, while the variant on the bottom right according to FIG. 9 has semicircular or half-oval inflow openings 18.

The inflow opening 18 or the multiple inflow openings 18 are preferably arranged in such a manner that they are oriented in the direction of the flow 11. In this manner, it is ensured that the cooling air that flows in the intermediate space 20 can enter the mixing element 15 in an effective and unobstructed manner.

According to the invention, the mixing openings 8 can be embodied in one row or in multiple rows. In an embodiment with multiple rows, the diameter and surface area relationships change analogously.

### PARTS LIST

1 combustion space
2 fuel nozzle
3 outer housing
4 inner housing
5 outer combustion chamber wall
6 turbine inlet guide vane
7 inner combustion chamber wall
8 mixing/mixing opening
9-12 air
13,14 cooling air
15 mixing element
16 impingement cooling hole
17 effusion cooling hole
18 inflow opening
19 radius
20 intermediate space
21 outer mixing hole
22 inner mixing hole
23 central axis
101 engine central axis
110 gas turbine engine/core engine
111 air inlet
112 fan
113 medium-pressure compressor (compactor)
114 high-pressure compressor
115 combustion chamber
116 high-pressure turbine
117 medium-pressure turbine
118 low-pressure turbine
119 exhaust nozzle
120 guide vanes
121 core engine housing
122 compressor rotor blades
123 guide vanes
124 turbine blades
125 compressor drum or compressor disc
126 turbine rotor hub
127 outlet cone

1. A gas turbine combustion chamber with a double-wall embodiment with
an outer cold combustion chamber wall and with an inner hot combustion chamber wall which form an intermediate space
with impingement cooling holes that are embodied in the outer combustion chamber wall,
with effusion cooling holes that are embodied in the inner combustion chamber wall,
with outer mixing holes that are embodied in the outer combustion chamber wall,
with inner mixing holes that are embodied in the inner combustion chamber wall, and
with respectively one tubular mixing element that connects the outer mixing hole and the inner mixing hole,
wherein
the mixing element is provided with at least one inflow opening in its area that is arranged in the intermediate space,
the outer mixing hole has a smaller diameter than the inner mixing hole, and
the throughflow surface area of the effusion holes adjoining the mixing element is reduced by the difference in surface area between the outer mixing hole and the inner mixing hole.

2. The gas turbine combustion chamber according to claim 1, wherein the mixing element is embodied in the form of a ring-like flange that is mounted at the inner combustion chamber wall.

3. The gas turbine combustion chamber according to claim 1, wherein the mixing holes are respectively arranged in one row around the circumference of the outer combustion chamber wall and the inner combustion chamber wall.

4. The gas turbine combustion chamber according to claim 1, wherein the inflow opening is embodied in a flow-optimized manner.

5. The gas turbine combustion chamber according to claim 4, wherein the inflow opening is embodied in a round or oval manner.

6. The gas turbine combustion chamber according to claim 4, wherein the inflow opening is embodied so as to be inclined with respect to the central axis of the mixing element.

7. The gas turbine combustion chamber according to claim 1, wherein the inflow opening is arranged in the flow direction of the cooling air through the intermediate space.

8. The gas turbine combustion chamber according to claim 1, wherein multiple inflow openings are embodied at the circumference of the mixing element.

9. The gas turbine combustion chamber according to claim 1, wherein the inflow openings are embodied in a slit-like manner.

10. The gas turbine combustion chamber according to claim 1, wherein the sum of the throughflow surface areas of the impingement cooling holes and the outer mixing holes is equal to the sum of the throughflow surface areas of the effusion cooling holes and the inner mixing holes.
